(19) United States
(12) Patent Application Publication
(10) Pub. No.: US 2021/0112630 A1
(43) Pub. Date: Apr. 15, 2021

(54) FEEDTHROUGH FOR AN ELECTRICAL HEATING DEVICE, ELECTRICAL HEATING DEVICE WITH SUCH A FEEDTHROUGH, SYSTEM WITH SUCH A FEEDTHROUGH, AND METHOD FOR MANUFACTURING SUCH A FEEDTHROUGH

(71) Applicant: Türk & Hillinger GmbH, Tuttlingen (DE)

(72) Inventor: Andreas SCHLIPF, Tuttlingen (DE)

(21) Appl. No.: 17/069,826

(22) Filed: Oct. 13, 2020

(30) Foreign Application Priority Data
Oct. 15, 2019 (DE) 10 2019 127 686.1

(51) Int. Cl. H05B 3/06; H05B 3/44

(52) U.S. Cl. CPC H05B 3/06; H05B 3/44

(57) ABSTRACT

A feedthrough is disclosed for feeding a connection for an electrical heating device through a metal wall for supplying the electrical heating device with current, wherein the connection is part of the feedthrough and is formed by a connection conductor, which is electrically isolated by an electrically insulating material from an outer sheath of the feedthrough that is made from a metal at least in some sections, wherein the connection has at least one exposed connection conductor section, in which the outer sheath has multiple outer sheath sections electrically insulated from each other in the longitudinal direction of the connection conductor. An electrical heating device with such a feedthrough, a system with such a feedthrough and a method for manufacturing such a feedthrough are also disclosed.

### CROSS-REFERENCE TO RELATED APPLICATION

This application claims priority under 35 U.S.C. § 119 to German Patent Application No. 10 2019 127 686.1, filed on Oct. 15, 2019, the disclosure of which is incorporated herein by reference in its entirety.

### BACKGROUND OF THE INVENTION

Electrical heating devices are already widely used for a plurality of applications. For many of these applications, it is necessary to arrange the electrical heating device within a volume. This produces the problem that an electrical connection for supplying the electrical heating device with current must be fed through the wall surface made of metal in a way that is electrically insulated from this wall surface, which can be realized by means of a feedthrough, as known, for example, from WO 96/41353.

For a whole series of applications, for example, in the automotive industry, this feedthrough is exposed to different, not insignificant loads due to operational conditions and possible environmental influences. Accordingly, the feedthrough must have sufficient mechanical stability, even under the influence of vibrations over the long term. Simultaneously, the penetration of moisture should be prevented if possible and the necessary creep resistance must be ensured. A comprehensive implementation of this set of requirements is a challenging technical problem. This is especially applicable, because, for the use of higher on-board electrical system voltages of, for example, 48 V, the previously already strict requirements become even stricter.

### BRIEF SUMMARY OF THE INVENTION

This problem is preferably solved by a feedthrough for an electrical heating device with the features described and claimed herein, a preferred electrical heating device with the features described and claimed herein, a preferred system with such a feedthrough with the features described and claimed herein, and a preferred method for manufacturing such a feedthrough with the features described and claimed herein. Advantageous refinements of the preferred invention are the subject matter of the respective dependent claims.

The feedthrough according to the invention for feeding a connection for an electrical heating device through a metal wall for supplying the electrical heating device with current has a connection that is part of the feedthrough and is formed by a connection conductor, which is electrically isolated by an electrically insulating material from an outer sheath of the feedthrough made from a metal at least in sections, wherein the connection has at least one exposed connection conductor section, in order to manufacture an electrical connection. The connection conductor can be, for example, a connection wire or connection pin, with which the electrical contact to the heating device is created first on the side of the metal wall on which the electrical heating device is arranged; it can also be, however, a connection wire or connection pin that is guided out of the electrical heating device, so that the feedthrough and electrical heating device form a cohesive system from the start.

It is essential to the invention that the outer sheath has multiple outer sheath sections electrically insulated from each other in the longitudinal direction of the conductor. In certain embodiments, it can also be made from these outer sheath sections.

In particular, a jacket tube that is partitioned into tube segments by cut-outs can form such an outer sheath with multiple outer sheath sections electrically insulated from each other in the longitudinal direction of the conductor.

Through this measure, a significant increase in the creep resistance is achieved by an increase of the air gap and creep distances or, in general, the insulation distance, while simultaneously the structural integrity of the feedthrough is guaranteed over almost its entire length.

In an especially preferred way, such an outer sheath can be easily realized by a metal sleeve with ring-shaped cut-outs. These ring-shaped cut-outs can have, in particular, an undercut, which is useful, in particular, if an electrically insulating material, in particular, an electrically insulating putty, is arranged in at least one area between two adjacent outer sheath sections, wherein this area is preferably filled with this material. This measure can contribute significantly to protecting the integrity of the electrically insulating material that is arranged between the connection conductor and outer sheath of the feedthrough and is often associated with advantages especially for the use of the feedthrough in humid and wet environments. However, it is also to be noted that the electrical insulation between the outer sheath sections can basically already be guaranteed reliably in many cases by an air gap in interaction with the electrically insulating material between the outer sheath sections.

If one of the outer sheath sections electrically insulated from each other in the longitudinal direction of the conductor is connected, preferably soldered or welded, to the metal wall, through which the electrical connection is fed into the feedthrough, the fluid tightness of a container or tube to the outside and to the metal wall, through which the feedthrough is fed, is guaranteed and even in systems that are exposed to vibrations during operation, a robust and long-term stable connection can be guaranteed.

It is especially preferred if the electrically insulating material, with which the connection conductor is electrically isolated from the outer sheath of the feedthrough made from a metal at least in sections, is compacted magnesium oxide, aluminum oxide, boron nitride, or a mixture of these materials. It can, however, also be constructed as a ceramic molded part or as a pressed part.

Just in connection with applications in which the feedthrough can be exposed to moisture, it has proven advantageous if the electrically insulating material, with which the connection conductor is electrically isolated from the outer sheath of the feedthrough made from a metal at least in sections has water-repellent properties at least in sections, especially in sections, in which it is not covered by the outer sheath, as is the case, e.g., in the area of an end surface of the feedthrough and/or in the areas at which the electrical insulation between different sections of the outer sheath is created. This can be achieved, in particular, in that the electrically insulating material is impregnated or sealed with a sealing compound in the sections in which it has water-repellent properties.

The electrical heating device according to the invention is distinguished by a feedthrough according to the invention, which can also be refined, in particular, in one of the ways described above.

The system according to the invention has a feedthrough according to the invention, which can also be refined, in particular, in one of the ways described above. Another mandatory part of the system is a metal wall, through which the feedthrough is fed and with which the feedthrough is connected, in particular, welded or soldered.

In many cases, systems in which the metal wall is the wall of a container or tube and in which the connection is connected in an electrically conductive way with an electrical heating device arranged in an interior of the container or tube are especially preferred. The electrical heating device can be, in particular, a heating cartridge, a tubular heating element, or a coiled tube cartridge, but also a directly powered structure, in particular, a metal or honeycomb structure. A feedthrough with cut-outs, however, can also be a part integrated in a heating cartridge and in particular a part of the unheated area in connection with the heating cartridge.

The method according to the invention for manufacturing a feedthrough according to the invention comprises, in particular, the steps
preparing a feedthrough for feeding a connection for an electrical heating device through a metal wall for supplying the electrical heating device with current, wherein the connection is part of the feedthrough and is formed by a connection conductor, which is completely electrically isolated by an electrically insulating material from an outer sheath of the feedthrough made from metal, which surrounds the electrically insulating material in the radial direction over the entire extent of the electrically insulating material, in the longitudinal direction of the connection, and
partitioning the outer sheath into multiple outer sheath sections electrically insulated from each other in the feedthrough direction.

In this procedure, it is possible, in particular, that the connection conductor, the electrically insulating material, and the outer sheath, which together form the feedthrough, are prepared as compacted bar stock.

The partitioning of the outer sheath in multiple outer sheath sections electrically insulated from each other in the feedthrough direction is preferably realized by metal-cutting machining.

In one advantageous refinement of the method for a series of applications, the intermediate space between at least two outer sheath sections electrically insulated from each other in the feedthrough direction is filled with an electrically insulating material, especially an electrically insulating putty. In this way, the relatively sensitive electrically insulating material, which insulates the connection conductor from the outer sheath of the feedthrough, can also be protected in these areas with respect to mechanical effects and the sensitivity of the feedthrough to moisture in the application environment can also be reduced.

It is especially preferred if the exposed connection conductor section is also generated by metal-cutting machining. In particular, it can be structured, e.g., by a thread. In this case, it is seen as advantageous if the exposed connection conductor section is also structured by metal-cutting machining.

Further reduction of the sensitivity of a feedthrough manufactured in this way can be achieved in that the electrically insulating material is impregnated or sealed with a sealing compound in at least one of the sections not arranged within the outer sheath.

### BRIEF DESCRIPTION OF THE SEVERAL VIEWS OF THE DRAWING

The foregoing summary, as well as the following detailed description of the preferred invention, will be better understood when read in conjunction with the appended drawings. For the purpose of illustrating the preferred invention, there are shown in the drawings embodiments which are presently preferred. It should be understood, however, that the invention is not limited to the precise arrangements and instrumentalities shown. In the drawings:

FIG. 1 is a side elevational, partial cross-sectional view of a first embodiment of a feedthrough in accordance with a preferred invention;

FIG. 2 is a side elevational, partial cross-sectional view of a second embodiment of a feedthrough in accordance with a preferred invention;

FIG. 3 is a side elevational, partial cross-sectional view of a third embodiment of a feedthrough in accordance with a preferred invention; and

FIG. 4 is an enlargement of a portion of the cross-sectional view of FIG. 3, taken from within circle Z of FIG. 3.

### DETAILED DESCRIPTION OF THE INVENTION

FIG. 1 shows a feedthrough 10 for feeding a connection for a not-shown electrical heating device through a metal wall for supplying the electrical heating device with current. The connection is connected rigidly to the feedthrough 10, so that it is an integral part of the feedthrough and its components are, in particular, also components of the feedthrough 10.

The connection is formed in the embodiment according to FIG. 1 by a connection conductor 11, which is electrically isolated by an electrically insulating material 12, e.g., by a ceramic molded part or compacted magnesium oxide, aluminum oxide or mixtures that contain these components, from an outer sheath 13 of the feedthrough made from a metal at least in sections. The connection and thus the feedthrough 10 has two exposed connection conductor sections 11a,11b, wherein here, as an example, a thread was cut into the connection conductor section 11a by metal-cutting machining, so that an electrical connection is enabled by screwing on an correspondingly shaped connector not shown here. The electrical connection of the connection conductor section 11b, which is designed in this example for the electrical contacting of a not-shown electrical heating device, can be realized, e.g., by crimping, soldering, or welding; in principle, of course, a plug-in connection is also possible.

In comparison to known feedthroughs of such type, one special feature of the feedthrough shown in FIG. 1 is that the outer sheath 13 has multiple outer sheath sections 13a,13b that are electrically insulated from each other in the longitudinal direction of the connection conductor 11, that is, the direction, in which the current flows as designed in the connection conductor 11 and that are electrically isolated from each other by the ring-shaped cut-out 13c or the air gap realized by this cut-out. In this embodiment, the outer sheath is even made from these outer sheath sections.

In this way, the creep resistance of the feedthrough is improved; in contrast to a solution in which the “naked” electrically insulating material 12 projects over the outer sheath 13, a significantly better mechanical stability and a reduced sensitivity to moisture are achieved.

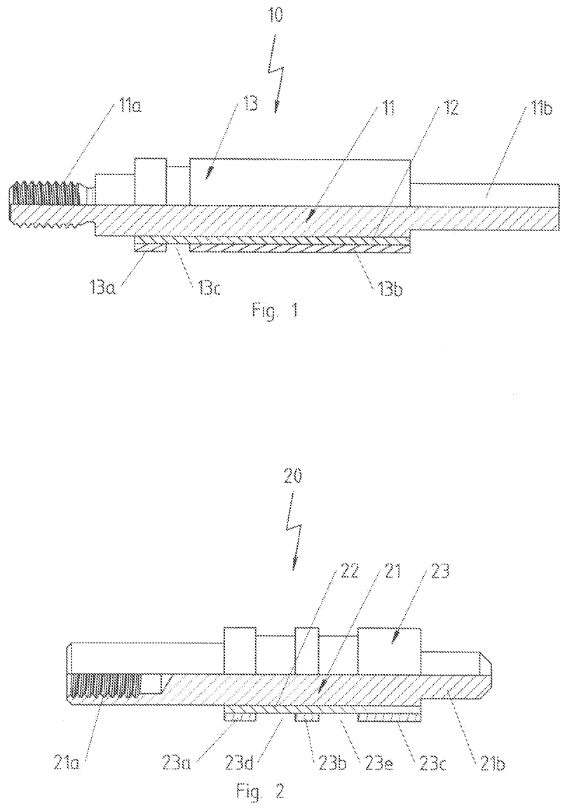

The feedthrough 20 shown in FIG. 2 consists of a connection conductor 21, which is electrically isolated by the electrically insulating material 22 from the outer sheath 23 made of metal. A first essential difference from the feedthrough 10 described above and shown in FIG. 1 consists in that the exposed connection conductor sections 21a, 21b are constructed differently, namely, the connection conductor section 21a is constructed with an internal thread cut in from the end side and the connection conductor section 21b is constructed in the form of a pin of a plug-in connector, which tapers at the end side. This shows some of the many degrees of freedom of construction for the actual manufacture of the electrical connection to the connection or to the feedthrough.

A second essential difference consists in that the outer sheath 23 has three outer sheath sections 23a, 23b, 23c, which are electrically isolated from each other and thus insulated from each other in the longitudinal direction of the connection conductor 21 by the ring-shaped cut-outs 23d, 23e and/or the air gap realized by these cut-outs. In this way, relatively large sections can also be realized without significant losses of mechanical stability and without large losses of moisture resistance.

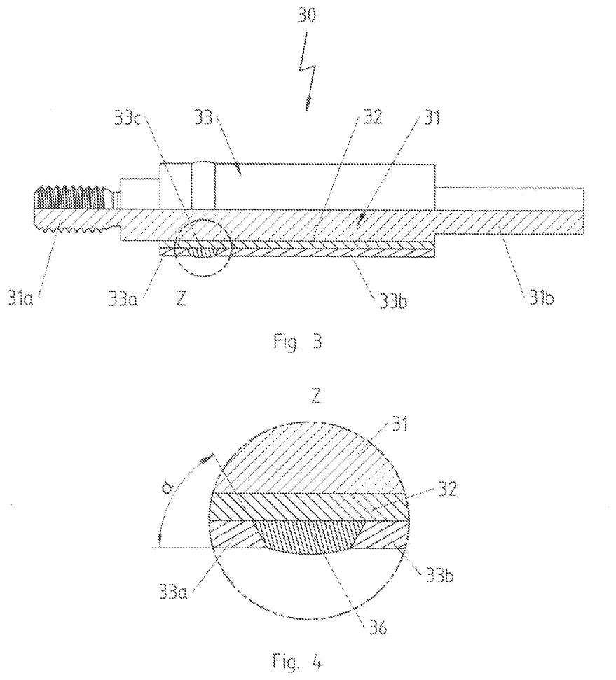

The feedthrough 30 shown in FIG. 3 and the associated cut-out enlargement according to FIG. 4 is, with respect to the connection conductor 21 with connection conductor sections 21a, 21b and the electrically insulating material 22, identical to the feedthrough 10 according to FIG. 1, but has differences with respect to the shape of the outer sheath 33. Similar to in FIG. 1, this is indeed partitioned into two metallic outer sheath sections 33a, 33b by the ring-shaped cut-out 33c, as can be seen particularly well in the enlargement of the detail Z in FIG. 4, but the ring-shaped cut-out 33c has an undercut and is filled with an electrically insulating material 36, for example, a ceramic putty. In this way, mechanical stability and moisture resistance can be noticeably increased.

It will be appreciated by those skilled in the art that changes could be made to the embodiments described above without departing from the broad inventive concept thereof. It is understood, therefore, that this invention is not limited to the particular embodiments disclosed, but it is intended to cover modifications within the spirit and scope of the present invention as defined by the appended claims.

### LIST OF REFERENCE SYMBOLS

10, 20, 30 Feedthrough
11, 21, 31 Connection conductor
11a, 11b, 21a, 21b, 31a, 31b Connection conductor section
12, 22, 32 Electrically insulating material
13, 23, 33 Outer sheath
13a, 13b, 23a, 23b, 23c, 33a, 33b Outer sheath section
13c, 23d, 23e, 33c Cut-out
36 Electrically insulating material
Z Detail

1-20. (canceled)

21. A feedthrough for supplying an electrical heating device with current through a metal wall, the feedthrough comprising:
a connection formed by a connection conductor, the connection conductor being electrically isolated by an electrically insulating material from an outer sheath, the outer sheath being constructed of a metal at least in sections, the connection having at least one exposed connection conductor section, the outer sheath having multiple outer sheath sections electrically insulated from each other in a longitudinal direction of the connection conductor.

22. The feedthrough according to claim 21, wherein the outer sheath is comprised of a metal sleeve with ring-shaped cut-outs.

23. The feedthrough according to claim 22, wherein the ring-shaped cut-outs have an undercut.

24. The feedthrough according to claim 22, wherein an electrically insulating material (36), comprised of an electrically insulating putty, is arranged in at least one area between two adjacent sheath sections of the multiple outer sheath sections.

25. The feedthrough according to claim 21, wherein one section of the multiple outer sheath sections electrically insulated from each other in the longitudinal direction of the connection conductor is connected with the metal wall, the one section being one of soldered and welded to the metal wall.

26. The feedthrough according to claim 21, wherein the electrically insulating material, with which the connection conductor is electrically isolated from the outer sheath, is comprised of one of compacted magnesium oxide, compacted aluminum oxide, compacted boron nitride, a compacted mixture of magnesium oxide, aluminum oxide and boron nitride materials, a ceramic molded part, and a pressed part.

27. The feedthrough according to claim 21, wherein the electrically insulating material, with which the connection conductor is electrically isolated from the outer sheath, has water-repellent properties in sections.

28. The feedthrough according to claim 27, wherein the electrically insulating material is one of impregnated and sealed with a sealing compound in the sections wherein the electrically insulating material has water-repellent properties.

29. The feedthrough according to claim 21, wherein the connection conductor is one of soldered and welded on an end side to a honeycomb structure, so that the honeycomb structure is mounted on the connection conductor.

30. The feedthrough according to claim 21, wherein a connection conductor section is connected to a system, the connection conductor section one of welded and soldered to the system.

31. The feedthrough according to claim 30, wherein the metal wall is the wall of one of a container and a tube, the connection formed by the connection conductor is connected in an electrically conductive way with an electrical heating device comprised of one of a heating cartridge, a tubular heating element, a coiled tube cartridge, and a directly powered structure, the directly powered structure comprised of one of a metal and a honeycomb structure, the electrical heating device arranged in an interior of the one of the container and the tube.

32. The feedthrough according to claim 31, wherein the connection conductor is one of soldered and welded at an end side to a honeycomb structure, the honeycomb structure being mounted on the connection conductor.

33. The feedthrough according to claim 21, wherein the outer sheath surrounds the electrically insulating material in a radial direction over an entire extent of the electrically insulating material, the outer sheath being partitioned into the multiple outer sheath sections.

34. The feedthrough according to claim 21, wherein the electrically insulating material and the outer sheath are prepared as compacted bar stock.

35. The feedthrough according to claim 21, wherein the multiple outer sheath sections are constructed by metal-cutting machining.

36. The feedthrough according to one of claim 21, wherein an intermediate space between at least two of the multiple outer sheath sections is filled with a second electrically insulating material (36), the second electrically insulating material comprised of electrically insulating putty.

37. The feedthrough according to claim 21, wherein an exposed connection conductor section of the connection conductor is constructed by metal-cutting machining.

38. The feedthrough according to claim 21, wherein the electrically insulating material is one of impregnated and sealed with a sealing compound in at least one section that is not arranged within the outer sheath.
